(19) United States
(12) Patent Application Publication
(10) Pub. No.: US 2026/0191183 A1
(43) Pub. Date: Jul. 9, 2026

(54) SYSTEMS AND METHODS FOR ANIMAL DETERRENCE AND CROP MANAGEMENT

(71) Applicant: Aerith, Inc., Oakwood, OH (US)

(72) Inventor: William Rossi, Oakwood, OH (US)

(73) Assignee: Aerith, Inc., Oakwood, OH (US)

(21) Appl. No.: 19/438,048

(22) Filed: Dec. 31, 2025

Related U.S. Application Data
(60) Provisional application No. 63/742,986, filed on Jan. 8, 2025.

(51) Int. Cl. A01M 29/06; G05D 1/683; G05D 1/698; G05D 105/50; G05D 107/20; G05D 109/20; G05D 111/10

(52) U.S. Cl. CPC A01M 29/06; G05D 1/683; G05D 1/6987; G05D 2105/50; G05D 2107/21; G05D 2109/20; G05D 2111/14

(57) ABSTRACT

Systems, methods, and apparatus for monitoring crop health via drones. The drones are operable to deter animals, spray chemicals, and remotely monitor soil health. A base station automatically determines a path for a drone, and, upon completion of the path, the drone returns to a docking station that charges the drone until the drone is redeployed.

### CROSS-REFERENCE TO RELATED APPLICATIONS

This application is related to and claims priority from the following US patents and patent applications: this application claims priority from and the benefit of U.S. Provisional Patent Application No. 63/742,986, filed Jan. 8, 2025, which is incorporated herein by reference in its entirety.

### BACKGROUND OF THE INVENTION

### 1. Field of the Invention

The present invention relates to crop management via drones. More specifically, the present invention relates to drones that are able to deter animals and/or monitor crop health.

### 2. Description of the Prior Art

It is generally known in the prior art to deploy drones in response to an event.

Prior art patent documents include the following:

US Patent Publication No. 2020/0201332 for a surveillance system for a wind park, and associated method by inventors Gunnar K. Storgaard Pedersen, et al., filed Jun. 21, 2018 and published Jun. 25, 2020, is directed to a providing a surveillance system for a wind park comprising a detection system configured to detect flying birds and issue a detection signal; one or more drones; and a control system configured to command one or more of said drones to be deployed based on the detection of birds flying in the vicinity of the wind park. The invention extends to a wind park comprising a plurality of wind turbines and a system as defined above. The invention also embraces a method of operating a surveillance system in a wind park, comprising scanning a geographical area proximal to a wind park using a surveillance system for the detection of birds; on detecting the presence of birds in the vicinity of the wind park, automatically commanding the deployment of one or more drones to act as a deterrent to the detected birds.

US Patent Publication No. 2020/0154695 for methods and systems for automatically relocating a pest deterrent system by inventor Brian Carnell, filed Nov. 15, 2019 and published May 21, 2020, is directed to systems and methods for chasing birds and other unwanted pest animals from a particular area. A robot system is used to relocate a pest deterrent in an area where a pest has been identified. The robot is programmed to move toward the pest animal within a geofenced area until the pest animal leaves the geofenced area. Robots (either ground based or flying robot drones) are programmed to move pest deterrent systems from one area to another to not allow a pest to become accustomed to the system. Two or more robots can be used in cooperation to adopt a complex strategy in chasing birds and other unwanted pest animals from a particular area.

US Patent Publication No. 2019/0387734 for Drone Control For Animals And Birds by inventors Brian E. Sullivan et al., filed Jun. 19, 2019 and published Dec. 26, 2019, is directed to a drone detonator for animal and bird control and a method for animal and bird control using the same. The detonator may include an actuator, a firing rod and a blank cartridge. The detonator may be detachably coupled to a drone. The actuator may move the firing rod from a first position to a second position to trigger detonation of the blank cartridge during drone flight. The actuator may be in communication with a remote control source. A method of animal and bird control using the drone detonator may include attaching the detonator to a drone, flying the drone to a target zone, and detonating the blank cartridge at the target zone.

US Patent Publication No. 2019/0110461 for a method and apparatus for identifying, locating and scaring away birds by inventor Paul Caskey, filed Oct. 14, 2017 and published Apr. 18, 2019, is directed to a method by which birds can be detected in a large outdoor area that may be a farmer's field or an international airport runway. Employing multiple cameras, a computer vision system will detect and identify bird flocks and calculate the location where they are flocking and/or landing. The GPS coordinates of the flock location are sent to an autonomous drone that will immediately launch and fly to that location. Once at the general location of the flock, the drone can fly any type of pre-programmed pattern, from simple circles to any complex patter of turns. Birds have long been a problem to the agriculture industry because of the devastating damage they can do to a crop in a very short period of time, or even dig up planted seed before the crop starts to grow. This invention will save untold time and expense to a wide range of growers. In addition to agriculture, this invention will be used to improve safety at airports chasing birds off runway approaches and any other places where birds present a nuisance or safety hazard. The drone has the ability to maintain an accurate low-altitude flight, typically less than 50′ above ground level, well below altitude of approaching aircraft.

US Patent Publication No. 2015/0127209 for a bird repellent system by inventors Ahmed Z. Al-Garni et al., filed Nov. 5, 2013 and published May 7, 2015, is directed to the bird repellent system is particularly adapted to repel various species of birds on and around airports, but may be readily adapted for use in other environments where birds have become a nuisance or hazard. The system includes both a ground vehicle and an airborne vehicle to optimize the effect against both sitting birds and birds in flight. Both vehicles are unmanned and operate autonomously, or by remote control as drones. The airborne vehicle is preferably a quad rotor craft for very slow and hovering flight. Both vehicles are equipped with GPS guidance and are preprogrammed to travel about a predetermined area or route. The two vehicles communicate with one another for optimum effect. Both vehicles include audio systems to broadcast startling sounds and/or bird distress cries in sound frequencies audible to humans as well as in ultrasonic frequencies known to be audible to various species of birds.

U.S. Pat. No. 9,474,265 for methods and systems for directing birds away from equipment by inventors William D. Duncan et al., filed Nov. 27, 2012 and issued Oct. 25, 2016, is directed to a system for directing a bird away from equipment including an item of equipment and a detector configured to detect a bird that could be harmed by or that could harm the equipment and to determine the proximity of the bird to the equipment. The system also includes an unmanned aerial vehicle and a pilot system configured to control the unmanned aerial vehicle.

U.S. Pat. No. 11,779,003 for a system and method for managing an insect swarm using drones by inventor Gandhi Karuna K T, filed Feb. 10, 2021 and issued Oct. 10, 2023, is directed to a system and method for managing an insect swarm using a plurality of drones. The method includes detecting an insect swarm. The method may further include tracking a movement of the insect swarm. The method further includes communicating, with remaining of the plurality of drones, to dynamically align in a position based on the tracking so as to make a drone formation. The method further includes magnetizing, by at least some of the plurality of drones, one or more drone couplers for electromagnetically coupling the at least some of the plurality of drones with each other as per the drone formation. The method further includes casting, by each of the plurality of drones, a net to trap insects in the insect swarm. The method further includes supplying, by each of the plurality of drones, a high voltage to the net to decapacitate the insects.

U.S. Pat. No. 11,291,198 for methods and systems for bird deterrence and maintenance thereof by inventor Brian Carnell, filed Nov. 15, 2019 and issued Apr. 5, 2022, is directed to systems and methods for effectively repelling pest animals (e.g., birds), including drones that adopt complex deterrent strategies (e.g., cooperative strategies), establishing a fuzzy boundary for a geofenced area and altering pest deterrent device flight patterns based on the characteristics of the fuzzy boundaries. Deterrence strategies can be selected based on the type of pest animals, and new deterrence strategies can be generated based on outcome feedback from previous strategies (e.g., combining aspects of preexisting deterrence strategies by utilizing an AI system). Drones can be automatically maintained by comparing current drone operational status with a predetermined threshold level. A maintenance robot (e.g., a drone) can autonomously rescues a working robot (e.g., another drone) that is in trouble.

US Patent Publication No. 2020/0154696 for methods and systems for discriminately dispatching birds within a predefined area by inventor Brian Carnell, filed Nov. 15, 2019 and published May 21, 2020, is directed to systems and methods for dispatching pest animals such as birds, rodents and other predefined pest animals from a particular area using computer vision and artificial intelligence to identify the pest and machine learning to continuously improve the system. The system is set to continuously monitor its predefined area for motion and an electronic system is used to collect electronic representation of an intruder and submit the representation to the system for processing. Based on the results of its identification, the system will make an intelligent decision as to whether to activate the dispatch mechanism.

The article “Engineering a Smart Scarecrow: Bird Deterrence with Drones,” by Shivam Goel, published May 2017, describes drone deployment to an area detected by a camera without real-time drone adjustments.

### SUMMARY OF THE INVENTION

The present invention relates to drone deployment for crop management.

More specifically, the present invention provides a unique drone deployment system that is able to detect and deter animals, adjust deployment strategy in real-time, and monitor crop health. The system is operable to automatically return deployed drones to a base station upon completing a task.

It is an object of this invention to automatically monitor crop health by preventing animals from destroying plants. It is also an object of this invention to collect valuable crop data via sensors on drones.

In one embodiment, the present invention provides a portable crop management system comprising a mobile unit and a base station, wherein the base station is operable to determine a location of at least one pest in a geographic area, wherein the base station is operable to activate at least one protocol to deploy a command drone and/or at least one support drone to the location of the at least one pest, wherein the at least one protocol is a pest search protocol for the command drone to verify the location of the at least one pest based on at least one on-drone sensor, and wherein the at least one protocol is dynamically updated based on animal behavior and environmental conditions.

In another embodiment, the present invention provides a method for portable crop management comprising providing at least one drone including at least one mounted sensor for detecting at least one pest, a base station determining a location of the at least one pest detected by the at least one mounted sensor, and the base station activating at least one protocol by deploying at least one drone and transmitting the location of the at least one pest to the at least one drone, the at least one drone commencing a pest search protocol and verifying the location of the at least one pest based on at least one on-drone sensor, and dynamically updating the at least one protocol based on animal behavior and environmental conditions.

In yet another embodiment, the present invention provides a portable crop management system comprising at least one mobile unit, at least one drone including at least one mounted sensor, and at least one base station, wherein at least one pole-mounted sensor is operable to detect a location of at least one pest in a geographic area, wherein the at least one drone includes a command drone and at least one support drone, wherein the at least one base station is operable to activate at least one protocol to direct the command drone and/or the at least one support drone to the location of the at least one pest, wherein the at least one protocol includes a pest deterrence protocol for deterring the at least one pest from the geographic area, and wherein the at least one protocol is dynamically updated based on animal behavior and environmental conditions.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates a crop monitoring system according to one embodiment of the present invention.

FIG. 2 illustrates a crop monitoring system according to another embodiment of the present invention.

FIG. 3A illustrates a docking station in a closed configuration according to one embodiment of the present invention.

FIG. 3B illustrates a docking station in a partially open configuration according to one embodiment of the present invention.

FIG. 4A illustrates a docking station in a closed configuration according to another embodiment of the present invention.

FIG. 4B illustrates a docking station in a partially open configuration according to one embodiment of the present invention.

FIG. 5A illustrates an animal detection moment according to one embodiment of the present invention.

FIG. 5B illustrates a drone response to an animal detection moment according to one embodiment of the present invention.

FIG. 6 illustrates a crop monitoring system response to an animal detection moment according to one embodiment of the present invention.

FIG. 7 illustrates a drone deterrent mechanism according to one embodiment of the present invention.

FIG. 8 illustrates a portable crop monitoring system according to one embodiment of the present invention.

FIG. 9A illustrates an exterior perspective view of a mobile unit of the present invention as described herein.

FIG. 9B illustrates an interior perspective view of the side of a mobile unit of the present invention as described herein.

FIG. 9C illustrates an aerial view of a mobile unit of the present invention as described herein.

FIG. 10 illustrates a schematic diagram according to one embodiment of the present invention.

### DETAILED DESCRIPTION

The present invention is generally directed to crop monitoring via a drone system.

In one embodiment, the present invention provides a portable crop management system comprising a mobile unit and a base station, wherein the base station is operable to determine a location of at least one pest in a geographic area, wherein the base station is operable to activate at least one protocol to deploy a command drone and/or at least one support drone to the location of the at least one pest, wherein the at least one protocol is a pest search protocol for the command drone to verify the location of the at least one pest based on at least one on-drone sensor, and wherein the at least one protocol is dynamically updated based on animal behavior and environmental conditions.

In another embodiment, the present invention provides a method for portable crop management comprising providing at least one drone including at least one mounted sensor for detecting at least one pest, a base station determining a location of the at least one pest detected by the at least one mounted sensor, and the base station activating at least one protocol by deploying at least one drone and transmitting the location of the at least one pest to the at least one drone, the at least one drone commencing a pest search protocol and verifying the location of the at least one pest based on at least one on-drone sensor, and dynamically updating the at least one protocol based on animal behavior and environmental conditions.

In yet another embodiment, the present invention provides a portable crop management system comprising at least one mobile unit, at least one drone including at least one mounted sensor, and at least one base station, wherein at least one pole-mounted sensor is operable to detect a location of at least one pest in a geographic area, wherein the at least one drone includes a command drone and at least one support drone, wherein the at least one base station is operable to activate at least one protocol to direct the command drone and/or the at least one support drone to the location of the at least one pest, wherein the at least one protocol includes a pest deterrence protocol for deterring the at least one pest from the geographic area, and wherein the at least one protocol is dynamically updated based on animal behavior and environmental conditions.

None of the prior art discloses a crop monitoring system including drones that respond to animal movement and adjust their paths in real-time based on the animal movement. In one embodiment, for the purposes of this application, in real-time means performing operations within less than 1 second.

The present invention includes a crop monitoring system that is able to deploy drones in response to detecting animals and drones that monitor plant health. The present invention includes a base station including a computer processor including an artificial intelligence engine, a docking station operable to house at least one drone, and at least one ground sensor.

Birds destroy over $150 million in crops annually. European starlings, blackbirds, and crows are known to damage grain, fruit, and berry plants by physically destroying and/or eating the crops. Birds either eat large portions of the crops before migrating, damage plant structure when landing on stalks/stems, and/or defecate on plants, making the produce unfit for human consumption. As birds damage the crops, the deteriorating plant health makes the crops more susceptible to other pests and pathogens, causing millions of dollars in agricultural losses each year. Further, traditional animal deterrent efforts add additional unquantifiable loss due to the time farmers spend manually preventing crop destruction by walking through the fields, hunting the animals, etc., as well as due to costs associated with ensuring human health and safety standards are maintained. Farmers have attempted to deter aerial animals by using sonic booms, scarecrows, or placing nets on the crops. Each prior art alternative is either ineffective, damages some plants in attempt to save the remaining plants, or is laboriously intensive. Therefore, there is an unmet need to automatically deter aerial animals without damaging crops.

Land-based animals also destroy crops. Deer consume/destroy millions of dollars in crops annually. Considering the millions of acres of farmland globally, it is impractical, and extremely costly, to fence in every farm to prevent deer from entering. Therefore, there is an unmet need to automatically deter ground-based animals from entering a farm before the animal destroys the crops.

Monitoring irrigation of a large farm is inherently difficult. Large sprinkler systems cover hundreds of acres of crops at a time before a farmer moves the irrigation system to another section of the farm. Practically, it is impossible to tell which areas of the farm have received sufficient water, and which areas of the farm have not received sufficient water. Farmers may physically check soil moisture by digging down a few inches and feel for soil consistency and/or visually assess moisture levels. The labor-intensive process of checking moisture content renders it impossible for a farmer to monitor an entire farm. A farmer only discovers insufficient irrigation to a particular area of a farm when the crops begin to deteriorate. Therefore, there is a need for a system that automatically assesses moisture content of an entire farm without human intervention.

Prior art systems fail to address the aforementioned problems. It is known in the art to detect a bird's location, send drones to the originally detected location, and have the drones return after conducting a preprogrammed sweep. These systems use cameras and drones to act as a falcon flying along a perimeter of a farm. However, birds are not stationary creatures. Although initially detecting a bird's location is important, the prior art fails to address the constant, and somewhat random, flight path of birds. Therefore, there exists a need for a drone system able to sense animal movement via at least one sensor on a drone and process the data in real-time to adjust a drone path accordingly.

None of the prior art provides a system that automatically detects animals that have penetrated the perimeter of a farm, determines the animal's location, deploys at least one drone to the animal's original location, tracks the animal's movement in real-time via on-drone sensors, and adjusts drone path in real-time based on the animal's movement.

Certain aspects of the presently disclosed subject matter of the invention, having been stated hereinabove, are addressed in whole or in part by the presently disclosed subject matter, and other aspects will become evident as the description proceeds when taken in connection with the accompanying illustrative examples and figures as best described herein below. Notably, terms such as “crops,” “farmland,” “farms,” “plants,” and synonyms thereof are used interchangeably and not intended to limit the invention. Further, “drones” refer to any unmanned vehicle, including both aerial and land-based vehicles.

Referring now to the drawings in general, the illustrations are for the purpose of describing a preferred embodiment of the invention and are not intended to limit the invention thereto.

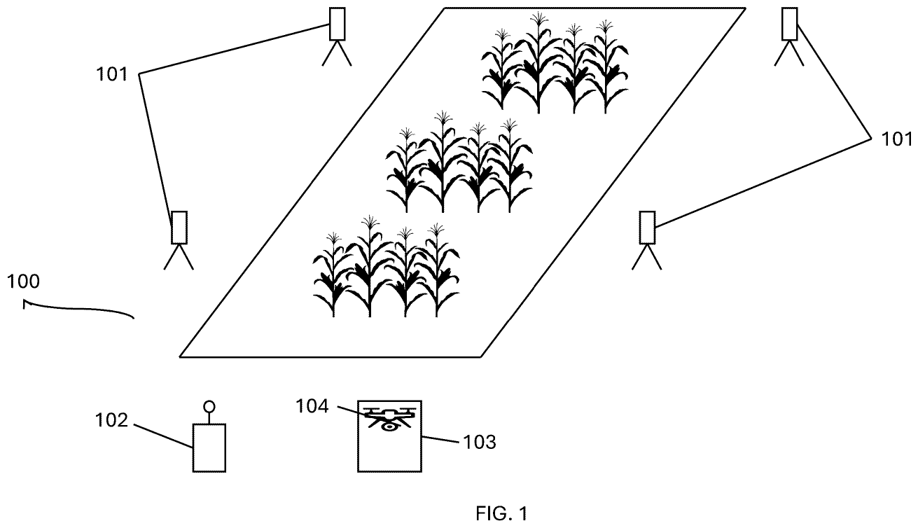

FIG. 1 illustrates a crop monitoring system 100 according to one embodiment of the present invention. In one embodiment, the crop monitoring system 100 includes at least one ground sensor 101. The at least one ground sensor 101 is positioned such that the at least one ground sensor 101 is operable to detect aerial movement and/or ground movement of animals. In one embodiment, the at least one ground sensor 101 is planted directly into the soil. In another embodiment, the at least on ground sensor 101 is on an elevated surface, such as a tripod. To detect animal movement, the at least one ground sensor 101 includes motion detection via the electromagnetic spectrum, echolocation, ultrasound, LiDAR, and/or other means. In one embodiment, the at least one ground sensor 101 uses microwave emitters/detectors to act as a radar system to detect animal movement. In another embodiment, the at least one ground sensor 101 uses infrared cameras to detect heat changes within a field of view. In another embodiment, the at least one ground sensor 101 uses a visible spectrum camera to take photos or initiate a video recording upon a detected change in a field of view. In another embodiment, the at least one ground sensor 101 includes microwave emitters/detectors, infrared cameras, a visible spectrum camera, and/or any combination thereof. The at least one ground sensor 101 records the detected animal movement and transmits the detected animal movement data to a base station 102. In one embodiment, the at least one ground sensor 101 transmits the detected animal movement data via cables. In another embodiment, the at least one ground sensor 101 transmits the detected animal movement data wirelessly.

Importantly, the at least one ground sensor 101 is operable to detect animal movement within a predefined boundary. In one embodiment, the at least one ground sensor 101 is stationary. In another embodiment, the at least one ground sensor 101 rotates and/or oscillates to survey a larger area. In one embodiment, the at least one ground sensor 101 is positioned along a perimeter of a farm, wherein the at least one ground sensor 101 is facing the farm such that the entire field of view of the at least one ground sensor 101 is within the perimeter of the farm.

In one embodiment, the crop management system 100 includes a plurality of ground sensors 101. In one embodiment, each of the plurality of ground sensors 101 includes Global Positioning System (GPS) sensors and a computer processor. A user can draw a boundary on a map that includes a plurality of longitudinal and latitudinal coordinates that the user wants the plurality of ground sensors 101 to observe. Each of the computer processors for each of the plurality of ground sensors 101 coordinate with each of the other plurality of ground sensors 101 to only survey an area within the plurality of longitudinal and latitudinal coordinates selected by the user. Each of the plurality of ground sensors 101 detects animal movement and transmits the detected animal movement to a base station 102.

The base station 102 includes a computer processor operable to transmit and receive data. The base station 102 is operable to receive data from at least one ground sensor 101, at least one drone 104, and a docking station 103. The base station 102 is further operable to transmit data to the docking station 103 and to the at least one drone 104. The base station 102 is equipped with an artificial intelligence engine that analyzes data obtained from the at least one ground sensor 101, the at least one drone 104, and/or the docking station 103.

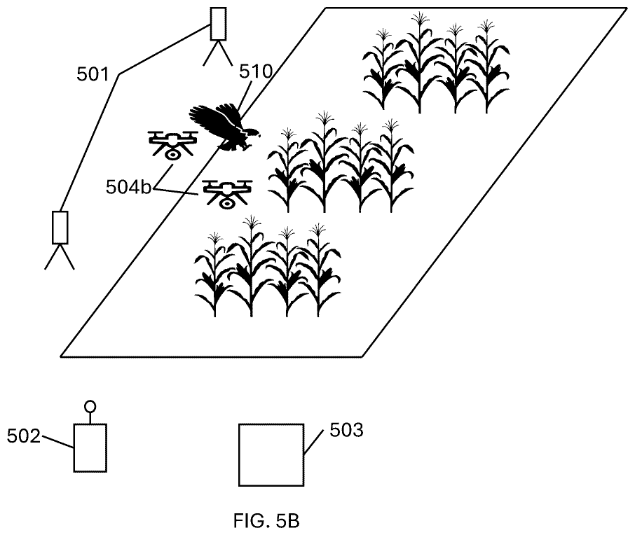

In one embodiment, the base station 102 is operable to receive animal movement from the at least one ground sensor 101, determine the position of the animal, transmit a command signal to the docking station 103 to release the at least one drone 104, and calculate a path for the at least one drone 104 based in part on the position of the animal. The base station 102 calculations are completed via the computer processor such that the calculations are not conducted on a remote server. The base station 103 is further operable to receive animal movement via at least one sensor on the at least one drone 104, analyze the animal movement via the artificial intelligence engine, and update the path for the at least one drone 104 in real-time based in part on the animal movement obtained via the at least one sensor on the at least one drone 104, as depicted in FIG. 5. In one embodiment, the base station 102 is integrated into the docking station 103. In another embodiment, the base station 102 is separate from the docking station 103, as depicted in FIG. 1.

Referring back to FIG. 1, in another embodiment, the base station 102 is operable to transmit a command signal to the docking station 103 to release the at least one drone 104 and calculate a path for the at least one drone 104 based in part on what data a user requires for crop health. In one embodiment, the base station 102 sends a command signal to the docking station 103 to release the at least one drone 104 to conduct a fly over of a farm to obtain soil moisture data. In another embodiment, the base station 102 is operable to transmit a command signal to the docking station 103 to release the at least one drone 104 to collect data available via sensors (e.g., electromagnetic sensors, echolocation sensors, ultrasonic sensors, etc.) on the at least one drone 104.

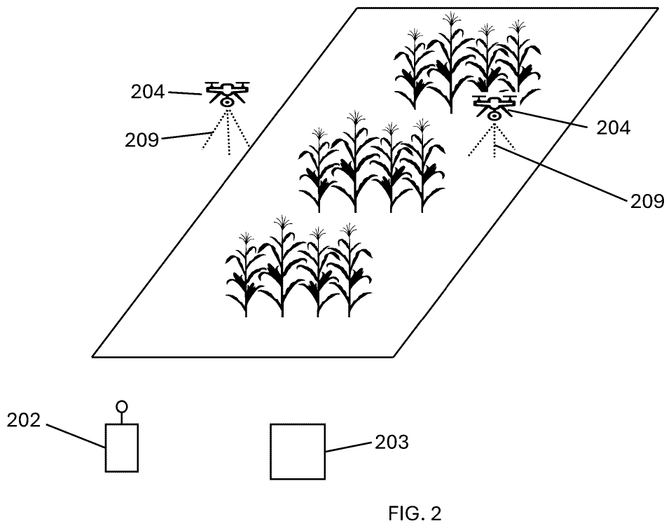

In yet another embodiment, depicted in FIG. 2, the base station 202 is operable to transmit a command signal to docking station 203 to release at least one drone 204 and calculate a path for the at least one drone 204 based in part on what portions of a farm require additional chemicals. In one embodiment, the base station 202 sends a command signal to the docking station 203 to release the at least one drone 204 to conduct a crop dusting with any chemical the crops require, such that the at least one drone 204 releases chemical 209 onto the crops. In this embodiment, the at least one drone 204 includes a tank sufficient to store the chemical 209 while the at least one drone 204 travels to a portion of the farm that requires additional chemicals. The at least one drone 204 further includes a nozzle operable to spray/release the chemical 209 onto the crops.

Referring back to FIG. 1, after the least one drone 104 completes a route, the at least one drone 104 automatically returns to the docking station 103. The docking station 103 includes a power source operable to charge the at least one drone 104. In one embodiment, the docking station 103 includes a hollow interior such that the docking station 103 houses the at least one drone 104 inside the hollow interior. Preferably, in one embodiment, the at least one docking station 103 is portable. In one embodiment, the docking station 103 is operable to house more than one drone.

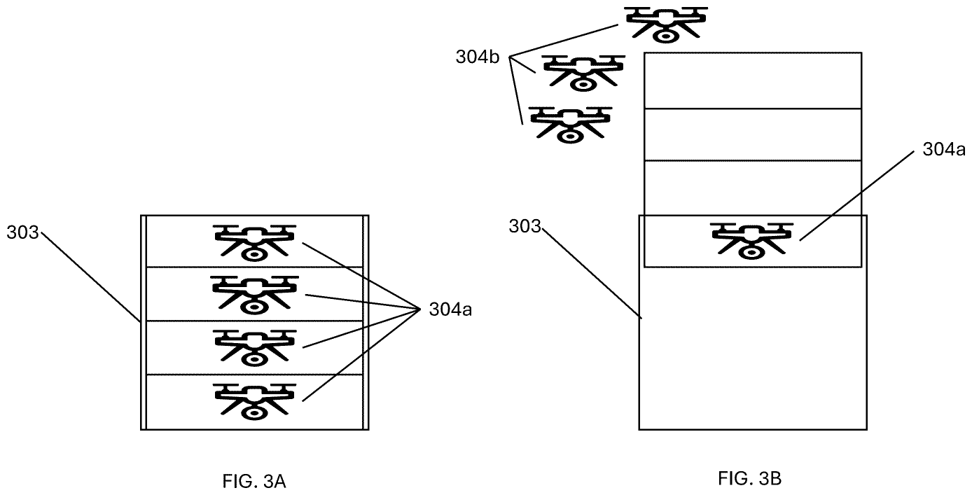

FIGS. 3A and 3B illustrate a docking station 303 in a closed and partially open configuration, respectively, according to one embodiment of the present invention. The docking station 303 includes an opening on one end such that an interior compartment is operable to move through the open end. The docking station 303 is operable to be in a closed, partially open, or fully open configuration. In the closed configuration, depicted in FIG. 3A, the docking station 303 houses at least one docked drone 304a. In the partially opened configuration, depicted in FIG. 3B, the docking station 303 houses at least one docked drone 304a and at least one deployed drone 304b. In the fully open configuration, not depicted, the docking station is empty such that all drones are deployed. In the embodiment depicted in FIGS. 3A and 3B, the docking station 303 includes a power source operable to move the interior compartment vertically, and/or horizontally. In this embodiment, the interior compartment acts as an elevator such that the interior compartment rises through the opening in docking station 303 to release docked drones 304a. For example, FIG. 3A depicts the interior compartment fully within the docking station 303, and FIG. 3B depicts the interior compartment partially extending through the opening such that there is at least one deployed drone 304b and at least one docked drone 304a. The at least one deployed drone 304b is operable to land in the same location the at least one deployed drone 304b took off from.

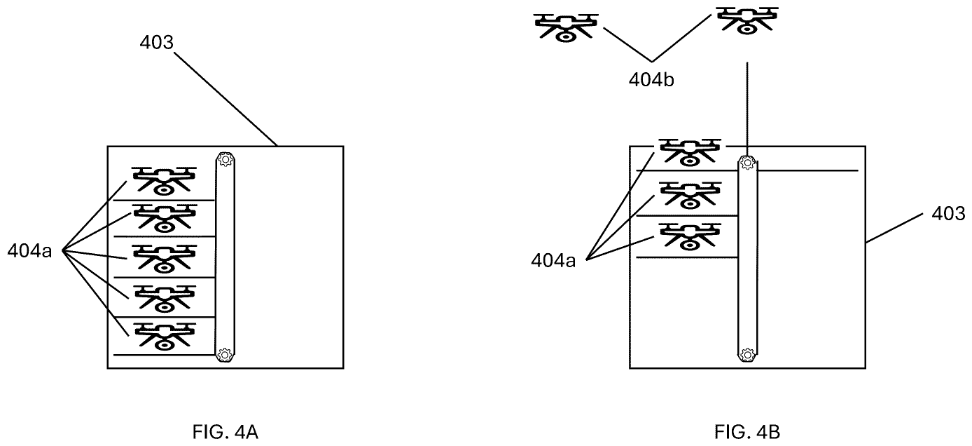

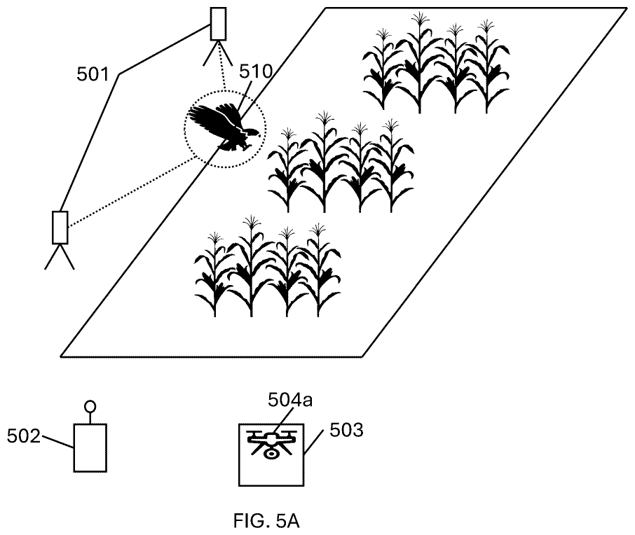

FIGS. 4A and 4B illustrate a docking station 403 in a closed and partially open configuration, respectively, according to another embodiment of the present invention. The docking station 403 includes an open end such that an interior compartment is operable to move through the open end. The docking station 403 is operable to be in a closed, partially open, or fully open configuration. In the closed configuration, depicted in FIG. 4A, the docking station 403 houses at least one docked drone 404a. In the partially opened configuration, depicted in FIG. 4B, the docking station 403 houses at least one docked drone 404a and at least one deployed drone 404b. In the fully open configuration, not depicted, the docking station is empty such that all drones are deployed. In the embodiment depicted in FIGS. 4A and 4B, the docking station 403 includes a power source operable to move the interior compartment vertically and/or horizontally. In this embodiment, the interior compartment acts as a rotating shelving unit such that the interior compartment rotates internally to the docking station 403. The internal compartment stops when a docked drone 404a gets to the open end of the housing unit such that the docked drone 404a is able to take off. The at least one deployed drone 404b is operable to land in the same location the at least one deployed drone 404b took off from, and the internal compartment rotates in the opposite direction to bring the at least one docked drone 404a into the interior of the docking station 403.

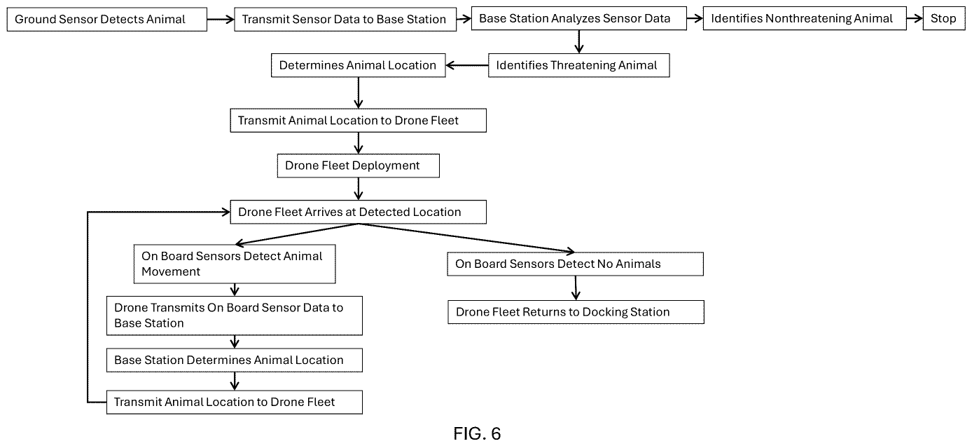

FIG. 5A illustrates an animal detection moment according to one embodiment of the present invention. In this embodiment, at least one ground sensor 501 senses an animal 510 (i.e., an animal detection moment) and transmits the data to base station 502. The base station 502 calculates a location of the animal 510 and transmits a command signal to the docking station 503 to deploy at least one docked drone 504a. In response to the command signal, the docking station 503 begins to move an internal component, creating a drone response, depicted in FIG. 5B. The at least one deployed drone 504b travels to the location of the animal 510 calculated by the base station 502 to deter the animal 510 from eating the crops. FIGS. 5A and 5B are a simplified version of an animal detection moment and a drone response, respectively, and are intended only to illustrate the specific drone response technique described in FIG. 6.

FIG. 6 illustrates a crop monitoring system response to animal movement according to one embodiment of the present invention. Advantageously, the crop monitoring system enables real-time adjustment of drone path in response to animal movement. FIG. 6 illustrates a decision tree in response to animal detection according to one embodiment of the present invention. First, at least one ground sensor detects animal movement within a pre-defined boundary (i.e., a farm). The at least one ground sensor transmits sensor data to a base station. The base station analyzes the sensor data. In one embodiment, the base station includes a computer processor and an artificial intelligence engine operable to determine the animal species. Then, the base station determines whether the identified animal species is threatening to the crops within the pre-defined boundary. If the animal is not threatening, the base station does nothing. If the base station determines that the animal species in threatening, the base station uses the at least one ground sensor data to determine a location of the animal. After the base station determines the animal's location, the base station transmits the animal's location to at least one drone (i.e., done fleet) and a docking station. The base station sends a command to the docking station to deploy the at least one drone. The transmitted animal location includes path/route instructions for the at least one drone. Then, the at least one drone travels to the animal's location determined by the base station via the path/route instructions. Once the at least one drone travels to the animal's location determined by the base station, at least one on-drone (i.e., onboard) sensor scans the location and relays the at least one on-drone sensor data to the base station. The base station analyzes the at least one on-drone sensor data to determine if the animal has moved from the time the base station calculated the animal's location via the at least one ground sensor data to the time the at least one drone arrived at the animal's location. If the base station determines that the animal has moved, the base station recalculates the animal's location and transmits a new location to the at least one drone and updates the path/route for the at least one drone in real-time. The at least one drone travels to the new location via the updated path/route. The drone continues to search for the animal until the at least one on-drone sensor fails to detect the animal. At that point, the at least one on-drone sensor transmits the on-drone sensor data to the base station, and the base station determines a return path/route for the at least one drone to return to the docking station. In one embodiment, the base station determines a route along the ground and transmits a location of a ground-based animal. In another embodiment, the base station determines an aerial route for the at least one drone and transmits a location of an aerial animal. Importantly, the present invention is operable to adjust aerial and ground drones simultaneously. In one embodiment, the at least one drone is operable to return to the docking station automatically if the at least one drone battery is below a predetermined threshold. In one embodiment, the artificial intelligence engine updates a deployment strategy after each of the at least one drone returns from deployment. For example, if an animal was detected at a particular location, the system deployed at least one drone to that location, the at least one drone returned to the base station, and the animal returned to that same location within a short period of time, the artificial intelligence engine would adjust the deployment strategy to ensure the animal does not return after a subsequent drone deployment.

The at least one on-drone sensor is operable to detect animal movement. To detect animal movement, the at least one on-drone sensor includes motion detection via the electromagnetic spectrum, echolocation, ultrasound, LiDAR, and/or other means. In one embodiment, the at least one on-drone sensor uses microwave emitters/detectors to act as a radar system to detect animal movement. In another embodiment, the at least one on-drone sensor uses infrared cameras to detect heat changes within a field of view. In another embodiment, the at least one on-drone sensor uses a visible spectrum camera to take photos or initiate a video recording upon a detected change in a field of view. In another embodiment, the at least one on-drone sensor includes microwave emitters/detectors, infrared cameras, a visible spectrum camera, and/or any combination thereof.

Importantly, drones according to the present invention are operable to transmit and receive signals. In one embodiment, the drones are operable to receive command signals from a base station and transmit sensor data to the base station. Further, the drones are operable to include GPS data such that each of the drones transmits its location to the base station, so the base station can update the drones' paths in real-time. In one embodiment, the drones include a leader drone that is always deployed first. In this embodiment, the leader drone approaches a location determined by the base station and relays data from the at least one on-drone sensor to the base station. The base station re-calculates an animal's location before deploying subsequent drones. In another embodiment, the drones are operable to include a modular design such that sensors, nozzles, wings, blades, and/or any other drone feature is detachable and interchangeable. The modular design enables a user to modify a drone feature to customize the drone for a particular task. For example, a visible spectrum camera is detachable and operable to be replaced by a liquid storage container with a nozzle if the drones are going to be deployed for crop dusting instead of animal deterrent.

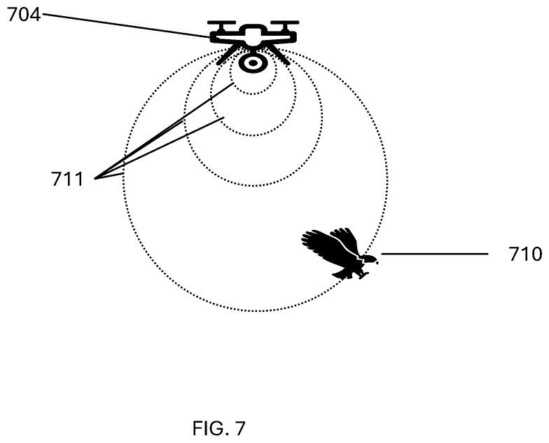

FIG. 7 illustrates a drone 704 including a deterrent mechanism according to one embodiment of the present invention. The drone 704 approaches animal 710. As the drone 704 arrives at the location of the animal 710, the drone 704 is operable to deter the animal 710. In one embodiment, depicted in FIG. 7, the drone 704 includes a deterrent mechanism including speakers emitting noise (i.e., sound waves) 711 sufficient to deter the animal 710 away from the current location of the animal 710. In one embodiment, the deterrent mechanism includes a predetermined drone swarm pattern, such as a wall of drones, circle of drones, a line of drones, or any other drone configuration, configured to deter the animal 710 from the current location of the animal 710. In one embodiment, the drone 704 includes flashing lights sufficient to deter the animal 710 away from the current location of the animal 710. In one embodiment, the drone 704 includes an aerial drone operable to hover over the animal 710 such that the wind produced by the blades of the aerial drone deters the animal 710 from its current location. In one embodiment, the deterrent mechanism includes speakers emitting noise, flashing lights, drone swarm patterns, and/or any other deterrent mechanism.

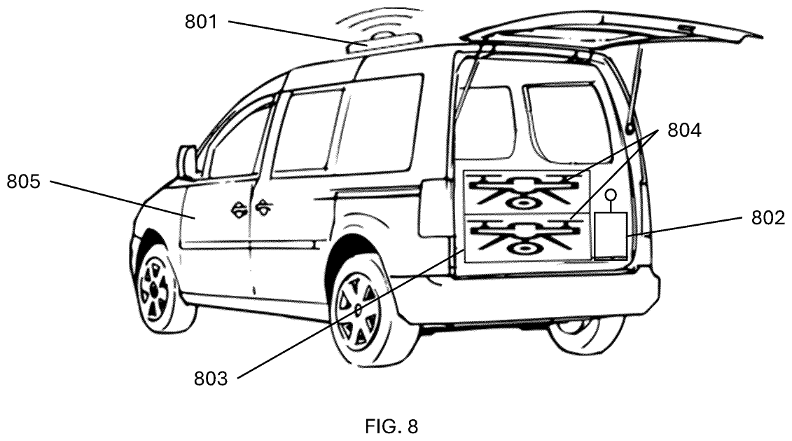

FIG. 8 illustrates a portable crop monitoring system according to one embodiment of the present invention. A vehicle 805 is operable to house a base station 802 and a docking station 803. The docking station 803 includes at least one drone 804. The vehicle 805 includes at least one sensor 801. In one embodiment, the at least one sensor 801 is operable to detect animal movement. To detect animal movement, the at least one sensor 801 includes motion detection via the electromagnetic spectrum, echolocation, ultrasound, LiDAR, and/or other means. In one embodiment, the at least one sensor 801 uses microwave emitters/detectors to act as a radar system to detect animal movement. In another embodiment, the at least one sensor 801 uses infrared cameras to detect heat changes within a field of view. In another embodiment, the at least one sensor 801 uses a visible spectrum camera to take photos or initiate a video recording upon a detect change in a field of view. In another embodiment, the at least one sensor 801 includes microwave emitters/detectors, infrared cameras, a visible light spectrum camera, and/or any combination thereof. In this embodiment, the portable crop monitoring system is operable to be completely housed within the vehicle 805 such that when the vehicle 805 detects an animal, the vehicle 805 is able to open such that the docking station 803 releases the at least one drone 804 to complete a task. The at least one drone 804 is operable to return to the docking station 803 after the task is complete. The vehicle 805 housing the docking station 803 and the base station 802 enables the system to be portable such that the vehicle 805 is able to move the portable crop monitoring system between various locations.

While embodiments disclosed herein refer to animal deterrent for crop monitoring, the aforementioned embodiments are intended as examples and not intended to limit the invention to a particular use. For example, in one embodiment, a drone system described herein is operable to deter animals from wind farms, airports, food storage silos, construction sites, and/or any other location and/or use where animals are undesirable without deviating from the disclosure described herein.

In one embodiment, a portable crop management system includes an autonomous drone pest deterrent system. In one embodiment, the autonomous drone pest deterrent system includes a command drone and at least one support drone. The command drone of the autonomous drone pest deterrent system is a leader drone, and a support drone provides assistance to the command drone for additional coverage and deterrence operations. In one embodiment, the command drone is a leader drone with at least one on-drone sensor. In a preferred embodiment, the at least one on-drone sensor includes an optical sensor and/or a thermal imaging system. In another embodiment, the command drone and the support drone include a thermal imaging system. Thermal imaging systems enhance pest detection of the autonomous drone pest deterrent system by detecting pests hidden in dense vegetation, bushes, and/or low light conditions. In another embodiment, the command drone is operable to identify at least one pest based on the thermal imaging system. In one embodiment, the command drone is operable to detect at least one pest and select a deterrence protocol based on at least one on-drone sensor and/or thermal imaging system. In another embodiment, a base station is operable to detect at least one pest and select a deterrence protocol and transmit an activation message to the command drone and/or the at least one support drone. The activation message transmitted by the base station includes a location for the at least one pest detected. In an exemplary embodiment, a command drone and/or at least one support drone is deployed to an area for at least one pest detected based on an activation message transmitted from a base station.

In one embodiment, a command drone arrives at the area that the base station determined the at least one pest is located within and commences a pest search protocol to determine a location of the at least one pest by utilizing the thermal imaging system and/or the at least one on-drone sensor of the command drone. In one embodiment, the pest search protocol includes a 360-degree spin, a vertical scan (raising and lowering altitude by several meters), and/or a flight pattern to detect the at least one pest detected by the base station. In one embodiment, the flight pattern is a circular flight path of the area detected by the base station. In another embodiment, the thermal imaging system and/or the at least one on-drone sensor continuously analyze the area detected by the base station via the pest search protocol. In one embodiment, the command drone activates a deterrence protocol and transmits the deterrence protocol to the at least one support drone upon detecting at least one pest. In another embodiment, the command drone is operable to detect behavior and/or environmental responses of the at least one pest and dynamically update protocol accordingly. The protocol is updated based on animal behavior and/or an environmental response of the at least one pest. In another embodiment, animal behavior is based on environmental factors including time of day (e.g., day, night, dawn, or dusk), crop species, abundance of shade (e.g., trees, tall trees, bushes, shrubs, infrastructure, clouds), and unfeasible drone terrain (e.g., adverse weather conditions, tall obstructions, fog, mist, air pollutants, enclosed area, mountainous terrain). In one exemplary embodiment, animal behavior includes the at least one pest being stagnant and hidden in dense vegetation, under cover, tall crops, tree lines, bushes, or low light conditions during a deterrence protocol. In another exemplary embodiment, animal behavior includes the at least one pest evading a deterrence protocol.

In an alternative embodiment, a command drone and at least one support drone commence a pest search protocol to determine a location of the at least one pest by utilizing the thermal imaging system and/or the at least one on-drone sensor of the command drone and the at least one support drone. In another embodiment, the command drone dynamically updates protocol based on an animal behavior, environmental response, and/or at least one pest detected by the pest search protocol.

In one embodiment, a command drone detects stagnant animal behavior using the at least one on-drone sensor and activates at least one protocol. The command drone communicates the at least one protocol to at least one support device and/or a base station. The command drone automatically and dynamically updates the protocol transmitted to the at least one support drone based on the stagnant animal behavior until evasive animal behavior is detected. In one embodiment, a command drone activates the at least one protocol for at least the duration the crop management system detects the at least one pest. In one embodiment, the base station continuously updates a command drone and/or at least one support drone based on a pole-mounted sensor detecting the at least one pest. The base station is operable to determine whether or not the protocol successfully deterred the at least one pest.

In one embodiment, a command drone includes a processor to process transmitted data from a base station and determine a protocol. In one embodiment, a command drone is comprised of a graphical processing unit (GPU). In another embodiment, a command drone is comprised of a plurality of processors. In another embodiment, support drones include a processor operable to process transmitted data from a command drone. In a preferred embodiment, support drones include a processor with lower computational power operable to reduce power consumption. In one alternative embodiment, a command drone includes a processor to process transmitted data from a base station and/or a support drone to dynamically determine a protocol. In another embodiment, a support drone includes a processor to process transmitted data from a base station and/or a command drone to dynamically determine a protocol.

In a preferred embodiment, the drones include at least two audio amplifier assemblies. The at least two audio amplifier assemblies are operable to be positioned on the drones in a plurality of orientations. In one embodiment, the drones include at least one forward-facing audio amplifier assembly and one downward-facing audio amplifier assembly. In another embodiment, the drones include at least one forward-facing audio amplifier assembly and one upward-facing audio amplifier assembly. In another embodiment, the drones include at least one upward-facing audio amplifier assembly and one downward-facing audio amplifier assembly. In another embodiment, the drones include at least one upward-facing audio amplifier assembly and at least one backward-facing audio amplifier assembly. In another embodiment, the drones include at least one downward-facing audio amplifier assembly and at least one backward-facing audio amplifier assembly. In another embodiment, the drones include at least one lateral facing audio amplifier assembly.

In one embodiment, the drones include a plurality of audio amplifier assemblies. In one embodiment, the autonomous drone includes a mount for the at least one audio amplifier assembly of a plurality of audio amplifier assemblies to face in any direction. In one embodiment, the drones that are operable to include at least two audio amplifier assemblies include command drones and support drones. In another embodiment, the drones that are operable to include at least one audio amplifier assembly include command drones and support drones.

In one embodiment, the at least one audio amplifier assembly is operable to emit deterrent tones for the at least one pest. In a preferred embodiment, the tones are targeted based on a species of the pest detected and minimize human deterrence and/or disturbance. In one embodiment, command drone and/or the support drone identifies the at least one pest and emits a targeted tone with the at least one audio amplifier assembly. In another embodiment, the at least one pole-mounted sensor in communication with the base station identifies the at least one pest and transmits an instruction message to a command drone and/or support drone. In one embodiment, the at least one pole mounted sensor, in communication with a base station, identifies at least one pest and the base station transmits an instruction message to a command drone and/or support drone to emit a target tone with at least one audio amplifier assembly.

In an exemplary embodiment, the targeted tone is modulated based on the species of the at least one pest, the species including but not limited to, a bird, deer, wild pig, and/or any other animal. In one exemplary embodiment, the target tone ranges from about 2 kHz to about 8 kHz to deter bird pests. In another exemplary embodiment, the target tone ranges from about 4 kHz to about 10 kHz to deter deer pests. In yet another exemplary embodiment, the target tone ranges from about 2 kHz to about 16 kHz to deter wild pig pests. In one embodiment, targeted tones incorporate varying modulated tones and randomized harsh tones to deter pests. In another embodiment, targeted tones maintain low human audibility and incorporate irregular sounds to maintain deterrence. In yet another embodiment, targeted tones emphasize higher frequencies of a range and randomized decibel level changes to maintain deterrence. In another embodiment, targeted tones are fine-tuned by an artificial intelligence (AI) engine operable to learn the frequency ranges of discomfort for the at least one pest and dynamically optimize the deterrence protocol. In another embodiment, a targeted tone is operable to be comprised of any frequency or frequency range.

In one embodiment, a deterrence protocol is determined based on a situational factor. A base station and/or autonomous drones include at least one sensor to detect at least one pest. The base station and/or autonomous drones then observes the at least one pest and calculate a situational factor. The determined observation indicates if the autonomous drones should deter the at least one pest from entering or exiting the farm terrain. The situational factor determines the intended use of the deterrence protocol. The situational factor includes deterring livestock from leaving farm terrain, deterring the at least one pest from entering the terrain, or other factors. In an exemplary embodiment, a base station instructs autonomous drones to commence a pest chase protocol based on a situational factor. In another exemplary embodiment, a base station determines a deterrence protocol to deter at least one pest to a most effective position (e.g., a tree line, outside of the crop area, side of a road, cliff) for deterrence based on a situational factor. In another embodiment, the command drone and/or the at least one support drone receives a deterrence protocol based on a situational factor from the base station. In another embodiment, the command drone determines a deterrence protocol based on a situational factor and transmits a message to at least one support drone.

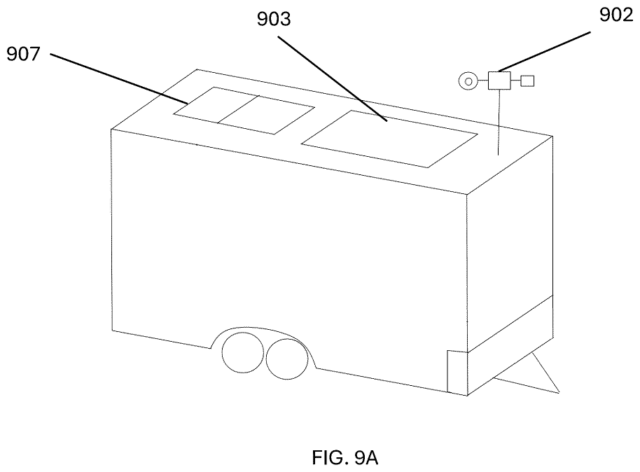

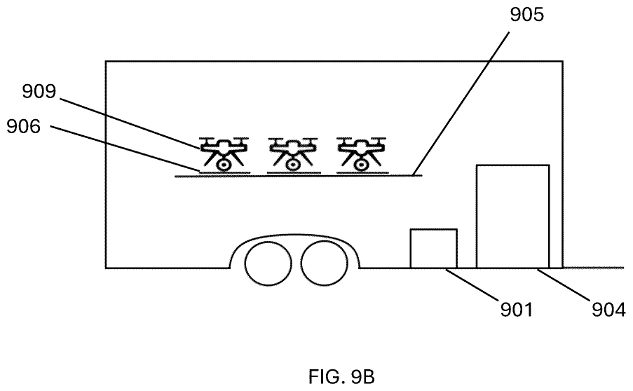

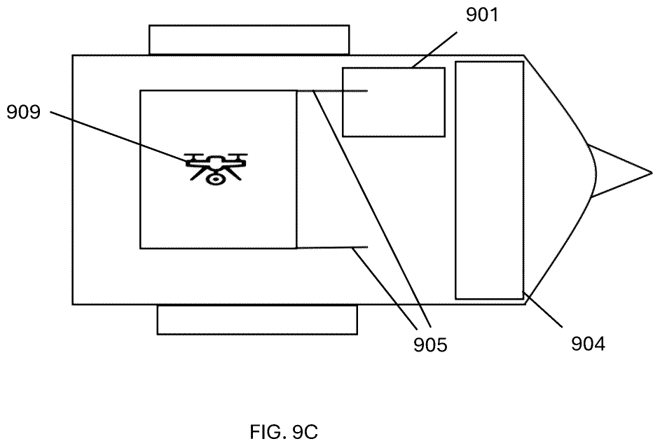

FIG. 9A illustrates an exterior perspective view of a mobile unit of the present invention as described herein. In one embodiment, a base station is embedded within a mobile unit operable to be easily transported and/or deployed to a location. In one embodiment, the at least one mobile unit comprises at least one battery. In a preferred embodiment, the base station of the mobile unit operates independently for an extended period of time via the at least one battery and autonomous drone operations.

In one embodiment, the at least one battery is connected to a solar charging array 903 mounted atop the mobile unit operable to generate power and charge a command drone, at least one support drone, a base station, and/or the at least one battery. In another embodiment, the at least one battery and/or solar charging array 903 includes continuous charging. In another embodiment, the at least one solar charging array 903 is operable to include a supplemental power source. In another embodiment, the mobile unit is in low light conditions and generates power by including a supplemental power source.

In one embodiment, the mobile unit is operable to mount a telescopic sensor and/or a pole-mounted sensor 902. The telescopic sensor and/or pole-mounted sensor 902 provide additional line of sight for detecting at least one pest. In one embodiment, the solar charging array 903 is comprised of a surface area less than the top of the mobile unit. In another embodiment, the solar charging array 903 is comprised of a surface area equal to the top of the mobile unit. In one embodiment, the solar charging array 903 is a surface area greater than the top of the mobile unit. In another embodiment, the solar charging array 903 includes a foldable portion for additional surface area. The foldable portion is supported by structural supports mounted at an angle to the sides of the mobile unit. In another embodiment, the mobile unit includes at least one extendable solar charging array 903 operable to extend and retract from the mobile unit. In one embodiment, the at least one battery and/or the solar charging array 903 of the mobile unit is operable to support an autonomous drone pest deterrence system requiring high-power demand environments and/or at least one multi-day operation. In another embodiment, the mobile unit includes an external auxiliary power support for high-power demand environments and/or multi-day operations.

In one embodiment, the mobile unit includes at least one pole-mounted sensor 902 operable to detect at least one pest. In a preferred embodiment, the at least one pole-mounted sensor 902 is mounted atop the mobile unit. In one embodiment, the mobile unit includes a processor operable to coordinate the autonomous drone pest deterrence system. In another embodiment, the processor is operable to dynamically update a deterrence protocol in real time. In an exemplary embodiment, a base station is operable to dynamically update a first deterrence protocol to a second deterrence protocol based on a behavior of the at least one pest detected. In one embodiment, the behavior of the at least one pest detected is based on environmental factors. In another embodiment, the base station continuously analyzes feedback transmitted from a command drone and/or at least one support drone to update and optimize the deterrence protocol of the command drone and/or at least one support drone to deter the at least one pest. In another embodiment, the base station generates at least one new deterrence protocol for deterring the at least one pest detected and/or a location.

In one embodiment, the mobile unit includes a hatch 907 to allow drone deployment and retrieval. In one embodiment, the hatch 907 is atop the mobile unit. In another embodiment, the hatch 907 is on the back of the mobile unit. In another embodiment, the hatch 907 is on a side of the mobile unit. In another embodiment, the mobile unit includes at least two hatches. In another embodiment, the base station activates a hatch 907 to open to release a command drone and/or at least one support drone to execute at least one deterrence protocol. In another embodiment, the base station activates a hatch 907 to close upon a command drone and/or at least one support drone returning from executing at least one deterrence protocol. In another embodiment, the hatch 907 closes directly after releasing the command drone and/or the at least one support drone. In another embodiment, the hatch 907 opens upon the return of the command drone and/or the at least one support drone. In one embodiment, autonomous drones 909 returning to a mobile unit are operable to dock and charge by power generated from the at least one battery. In one embodiment, autonomous drones 909 docked in the mobile unit are operable to receive maintenance. Maintenance includes repairs, software updates, and/or installing at least one deterrence protocol generated by the at least one base station.

In one embodiment, the at least one pole-mounted sensor provides real time pest detection and location verification to a base station and/or autonomous drones 909. In another embodiment, the at least one pole-mounted sensor utilizes a camera assembly for detecting at least one pest. In a preferred embodiment, the camera assembly is comprised of a thermal imaging camera for initial detection of at least one pest, an autonomous zooming infrared (IR) camera for precise position confirmation for the at least one pest detected by the thermal imaging camera, and a visual optical camera. In another embodiment, detection and confirmation of the at least one pest by the thermal imaging camera and the IR camera reduces false detections.

In one embodiment, a camera assembly of the at least one pole-mounted sensor includes adjustable primary camera configurations based on environmental factors. In an exemplary embodiment, a daytime configuration utilizes a visual optical camera based on environmental factors including daytime and environmental brightness. In another exemplary embodiment, a nighttime configuration utilizes a thermal imaging camera and an IR camera based on environmental factors including nighttime or environmental darkness. Environmental brightness and environmental darkness are operable to be determined by weather conditions, celestial conditions (e.g., Solar Eclipse, Aurora Borealis, etc.), and/or time of day. In a preferred embodiment, the camera assembly is a dual-camera assembly comprised of primary camera configurations including a daytime configuration and a nighttime configuration by monitoring for at least one pest based on environmental factors. In another embodiment, primary camera configurations include a bright environment configuration and a dark environment configuration. Primary camera configurations allow for adaptability in monitoring for the at least one pest by the base station regardless of environmental conditions. In an alternative embodiment, the at least one pole-mounted sensor includes a camera assembly utilizing a daytime configuration and verifies detection of the at least one pest by reconfiguring to a nighttime configuration.

In one embodiment, a mobile unit and at least one pole-mounted sensor are customized and/or adjustable for optimal detection of at least one pest based on farm terrain, pest type, and crop density. A high crop density indicates a strong hiding spot for the at least one pest. A low crop density indicates a weak hiding spot for the at least one pest. The mobile unit will easily detect the at least one pest by adjusting the at least one pole-mounted sensor based on crop density. Customizations include adjusted sensor and/or camera mounting heights, adjusted sensor field of view angles, and/or customizable camera specifications for optimal detection for at least one pest in a farm terrain and a crop density.

FIG. 9B illustrates an interior perspective view of the side of a mobile unit of the present invention as described herein. In one embodiment, the mobile unit is operable to include a rail-style housing with rails 905 for autonomous drones 909. In another embodiment, the mobile unit includes a cubby-style housing for autonomous drones 909. All housings for autonomous drones 909 are operable to provide conductive charging to autonomous drones 909 via a conductive charging pad 906. In one embodiment, the mobile unit includes a power grid 904 configuration for supplying charge to the at least one battery, the at least one autonomous drone 909, the conductive charging pad 906, and/or the at least one processor 901.

FIG. 9C illustrates an aerial view of a mobile unit of the present invention as described herein. In another embodiment, the power grid 904 and/or the solar charging array 903 are operable to charge the at least one battery, at least one autonomous drone, and/or the at least one processor 901. In one embodiment, the mobile unit houses internal components to enable a balanced weight distribution for at least one battery, processor 901, and/or power grid 904. In one embodiment, the mobile unit includes a hatch 907 with an extendable rear sliding platform. In one embodiment, the mobile unit includes a processor 901 operable to coordinate the autonomous drone pest deterrence system. In another embodiment, the processor 901 is operable to dynamically update a deterrence protocol in real time.

In one embodiment, a base station is comprised of a processor 901 operable to maintain low power consumption and faster data processing. In one embodiment, the camera assembly is comprised of a camera including thermal imaging, IR, and/or visual optical functionality. In another embodiment, the base station and/or the at least one a pole-mounted sensor 902 is operable to be fully powered by a solar charging array. In one embodiment, the at least one pole-mounted sensor 902 and/or processor 901 of the base station are modular to optimize detection of the at least one pest based on the pest type, farm terrain, and crop density. In one embodiment, the at least one pole-mounted sensor 902 optimizes detection of the at least one pest by utilizing a low power consumption configuration to increase the affordability of the mobile unit.

In one embodiment, an autonomous drone includes a home protocol, a deterrent protocol, and/or a pest search protocol initiated based on at least one pole-mounted sensor 902 of a base station. In another embodiment, a commander drone is operable to initiate the home protocol and/or the deterrent protocol based on at least one on-drone sensor. In another embodiment, a home protocol and/or a deterrent protocol is initiated based on environmental conditions and/or mission requirements. Mission requirements determine the desired outcome of the autonomous drone pest deterrence system. A mission requirement is satisfied based on the desired outcome. In one embodiment, each protocol is operable to dynamically switch protocols in real time for an autonomous drone based on at least one pole-mounted and/or at least one on-drone sensor. In an exemplary embodiment, an autonomous drone is operable to switch from a deterrence protocol to a pest search protocol if the at least one pest detected by the base station is not visible upon arrival of the autonomous drone. In another exemplary embodiment, an autonomous drone is operable to switch from a deterrence protocol to a home protocol if remaining power of the autonomous drone is below a threshold. In another embodiment, the threshold for activating a home protocol based on remaining power of at least one battery is a percentage from 1 to 50. In one embodiment, the threshold for activating a home protocol based on remaining power of the at least one battery is between about 5 to about 20 percent. In one embodiment, the threshold for activating a home protocol based on remaining power of the at least one battery is between about 5 to about 10 percent. In one embodiment, the threshold for activating a home protocol based on remaining power of the at least one battery is between about 20 to about 30 percent. In one embodiment, the threshold for activating a home protocol based on remaining power of the at least one battery is between about 1 to about 15 percent.

In one embodiment, a home protocol initiates an instruction for an autonomous drone to return to a mobile unit based on satisfied mission requirements. In one embodiment, the home protocol calculates an optimal route for an autonomous drone to return to a mobile unit. In another embodiment, an optimal route calculated by the home protocol is based on location, weather conditions (e.g., wind, rain, snow, sleet, hail), and remaining power of an autonomous drone. In one embodiment, a home protocol is instructed by a base station, a commander drone, manual operator, and/or weather conditions. In an exemplary embodiment, an autonomous drone on a mission activates a home protocol based on precipitation and/or any other weather condition that negatively affects the ability of the autonomous drone to travel.

In one embodiment, a home protocol further includes a landing subprotocol based on at least one on-drone sensor. The landing subprotocol of the home protocol includes an autonomous drone detecting RFID markers and/or a fiducial marker located on a landing platform of the mobile unit. Upon landing, the autonomous drone further includes precisely aligning and connecting with a designated conductive charging dock or contact pad of the mobile unit. In another embodiment, each conductive charging dock or contact pad for an autonomous drone is distinguishable by an RFID marker and/or a fiducial marker. In one embodiment, an autonomous drone connects to a conductive charging dock or a contact pad and activates a low-power state, uploads mission data from a most recent mission, and automatically charges.

In one embodiment, a deterrence protocol is designed to detect, identify, deter, and heard at least one pest outside of a crop system. A deterrence protocol utilizes at least one on-drone sensor and at least one pole-mounted sensor 902 to dynamically adjust the deterrence protocol in real time. In one embodiment, a commander drone and/or at least one support drone is operable to independently and/or cooperatively operate at least one deterrence protocol. In a preferred embodiment, the command drone communicates with at least one support drone to execute at least one deterrence protocol in real time. The command drone and the at least one support drone communicate in real time via a low-latency communications link.

In one embodiment, a deterrence protocol includes a sheepdog protocol operable to herd the at least one pest outside of a crop system and/or to a safe zone in a controlled manner. In another embodiment, the sheepdog protocol guides the at least one pest to a safe zone defined by a base station. In another embodiment, a safe zone is manually defined by an operator. The base station is operable to identify a plurality of pests and define a herding boundary. In another embodiment, a command drone and at least one support drone form a V-formation or U-formation. The V-formation and the U-formation include a command drone in the center and behind the at least one support drone. The at least one support drone forms the wings of the formation and is in front of the command drone to form a U-formation or V-formation to encompass the plurality of pests. In one embodiment, a command drone and at least one support drone emits a deterrent tone and/or a visual deterrent to herd the plurality of pests. A visual deterrent includes flight patterns, LED lights, and/or strobe patterns. In another embodiment, the formation of the command drone and at least one support drone is adjusted based on animal behavior in real-time. In another embodiment, the adjustable formation is operable to herd the plurality of pests to a safe zone. In another embodiment, the sheepdog protocol is operable to herd the plurality of pests in real-time based on the at least one on-drone sensor. A thermal imaging system and an optical sensor provide feedback for animal behavior of the plurality of pests in real time to a command drone and/or a support drone. In one embodiment, animal behavior feedback from the thermal imaging system and optical sensor is further operable to dynamically optimize the sheepdog protocol and/or minimize animal stress in real time. In another embodiment, the sheepdog protocol is operable to adjust formation of the command drone and the at least one support drone.

In one embodiment, a deterrent protocol includes a pest scare protocol operable to rapidly deter at least one pest. In one embodiment, a base station detects the at least one pest and activates a pest scare protocol for immediate initiation of a command drone and at least one support drone. The base station determines a location of the at least one pest detected by the at least one pole-mounted sensor 902 and activates the pest scare protocol by transmitting the location to at least one autonomous drone. In one embodiment, the at least one autonomous drone includes a command drone and at least one support drone. In one embodiment, the at least one autonomous drone arrives at the location of the at least one pest detected and initiates a visual deterrent and/or emits a deterrent tone by at least one audio amplifier assembly. In one embodiment, the pest scare protocol activates based on a base station and at least one pole-mounted sensor 902. The autonomous drones do not require the use of an on-drone sensor for target verification during the pest scare protocol. In one embodiment, the pest scare protocol is a short-range deterrence and first response measure for immediate action by the autonomous drone pest deterrent system. In one embodiment, an autonomous drone behavior is pre-scripted for the pest scare protocol. In another embodiment, an autonomous drone behavior is customizable based on duration, flight pattern, and audio range for deterrent tones.

In one embodiment, a deterrent protocol includes a pest chase protocol operable to rapidly track and deter at least one pest. In another embodiment, a base station detects the at least one pest and activates a pest chase protocol for immediate initiation of autonomous drones including a command drone and at least one support drone. In one embodiment, the pest chase protocol is activated after a pest scare protocol. In a preferred embodiment, the autonomous drones utilize on-drone sensors for verification of at least one pest. In one embodiment, the pest chase protocol is operable to track, predict and chase pests attempting to enter and/or re-enter the crop area. In one embodiment, the command drone and/or the at least one support drone utilize a thermal imaging system and an optical sensor to verify detection of the at least one pest. In another embodiment, the command drone and/or the at least one support drone utilize at least one on-drone sensor to detect and locate the at least one pest within a defined radius. In another embodiment, a defined radius is determined by the at least one command drone and/or the base station based on at least one pole-mounted sensor 902. In one embodiment, the command drone detects the at least one pest and transmits data to the at least one support drone, calculates a path prediction of the at least one pest, and chases the at least one pest while emitting deterrent tones. In an exemplary embodiment, path prediction of the at least one pest is calculated by a processor of the autonomous drone and/or the base station based on data from at least one sensor. In one embodiment, the autonomous drones are a safe distance away from the at least one pest such that the autonomous drones do not directly contact the at least one pest. In another embodiment, the autonomous drones emit varying deterrent tones. In another embodiment, the autonomous drones emit targeted tones. In one embodiment, the pest chase protocol dynamically adjusts flight pattern including velocity, altitude, and/or pathing. In a preferred embodiment, the pest chase protocol dynamically adjusts flight pattern based on animal behavior and environmental conditions. In another embodiment, the pest chase protocol is utilized in combination with at least one deterrence protocol. In an exemplary embodiment, the pest chase protocol is activated to chase the at least one pest that escaped from the plurality of pests herded by the sheepdog protocol. The pest chase protocol is operable to chase the at least one pest out of the crop area or to the plurality pests. In another exemplary embodiment, the pest chase protocol is activated to chase at least one pest of the plurality of pests before activating the sheepdog protocol. In yet another exemplary embodiment, the pest chase protocol is activated upon detection of the at least one pest based on a pest search protocol.

In a preferred embodiment, the protocols of the autonomous drone pest deterrent system are operable to be used interchangeably or in combination for optimized pest detection, identification, herding, and/or deterrence. In one embodiment, the autonomous drones include an on-drone spray system operable to spray a substance on the at least one pest based on animal behavior. In an exemplary embodiment, the autonomous drone detects at least one stubborn pest based on animal behavior and the sprays the at least one pest to expedite deterrence. In one embodiment, the at least one pest is labeled as stubborn upon not responding to deterrent tones. In a preferred embodiment, the substance is water. In one embodiment, the substance is operable to be any animal-safe liquid. In another embodiment, the substance is operable to be any liquid. In another embodiment, the spray system activates upon

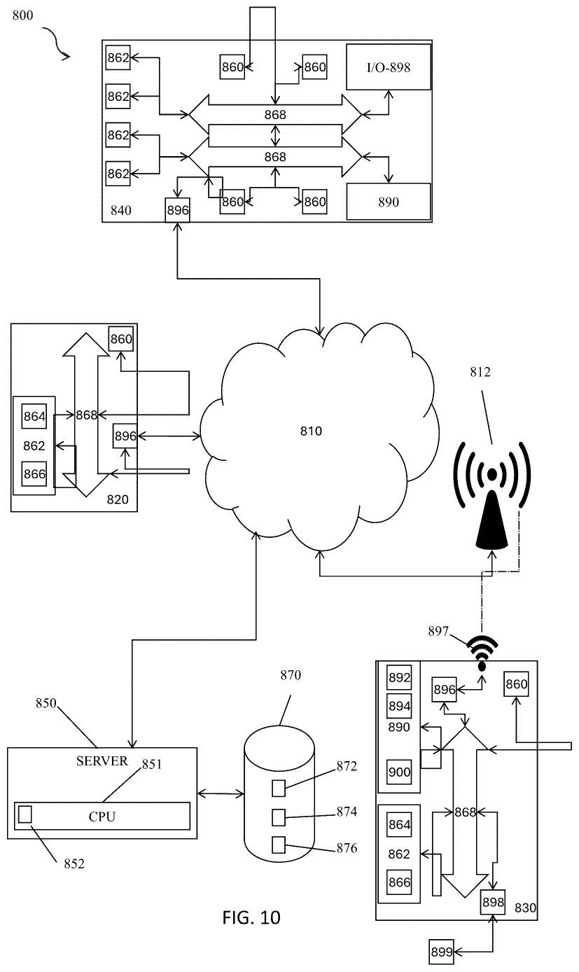

FIG. 10 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, signal generation devices (e.g., speakers), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 10, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

It is also contemplated that the computer system 800 is operable to not include all of the components shown in FIG. 10, is operable to include other components that are not explicitly shown in FIG. 10, or is operable to utilize an architecture completely different than that shown in FIG. 10. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

The above-mentioned examples are provided to serve the purpose of clarifying the aspects of the invention, and it will be apparent to one skilled in the art that they do not serve to limit the scope of the invention. By nature, this invention is highly adjustable, customizable and adaptable. The above-mentioned examples are just some of the many configurations that the mentioned components can take on. All modifications and improvements have been deleted herein for the sake of conciseness and readability but are properly within the scope of the present invention.

The invention claimed is:

1. A portable crop management system, comprising:
a mobile unit; and
a base station;
wherein the base station is operable to determine a location of at least one pest in a geographic area;
wherein the base station is operable to activate at least one protocol to deploy a command drone and/or at least one support drone to the location of the at least one pest;
wherein the at least one protocol is a pest search protocol for the command drone to verify the location of the at least one pest based on at least one on-drone sensor; and
wherein the at least one protocol is dynamically updated based on animal behavior and environmental conditions.

2. The portable crop management system of claim 1, wherein the at least one on-drone sensor includes a thermal imaging system and/or an optical sensor.

3. The portable crop management system of claim 1, wherein the command drone is operable to transmit the at least one protocol to the at least one support drone.

4. The portable crop management system of claim 1, wherein the at least one protocol includes a deterrence protocol.

5. The portable crop management system of claim 4, wherein the deterrence protocol activates upon verification of the location of the at least one pest determined by the base station.

6. The portable crop management system of claim 1, wherein the at least one protocol defaults to a home protocol for the command drone and/or the at least one support drone based on a remaining power being below a threshold.

7. The portable crop management system of claim 1, wherein the at least one protocol includes a sheepdog protocol for herding the at least one pest.

8. The portable crop management system of claim 1, wherein the mobile unit includes a solar charging array to charge at least one battery of the mobile unit, the command drone, and/or the at least one support drone.

9. The portable crop management system of claim 1, wherein the at least one protocol is dynamically updated based on animal behavior and environmental conditions.

10. A method for portable crop management, comprising:
providing at least one drone including at least one mounted sensor for detecting at least one pest;
a base station determining a location of the at least one pest detected by the at least one mounted sensor; and
the base station activating at least one protocol by deploying at least one drone and transmitting the location of the at least one pest to the at least one drone;
the at least one drone commencing a pest search protocol and verifying the location of the at least one pest based on at least one on-drone sensor; and
dynamically updating the at least one protocol based on animal behavior and environmental conditions.

11. The method for portable crop management of claim 10, wherein the at least one mounted sensor includes at least one thermal imaging sensor and/or an optical sensor.

12. The method for portable crop management of claim 10, wherein the at least one drone includes a command drone operable to transmit the at least one protocol to at least one support drone.

13. The method for portable crop management of claim 10, wherein the at least one protocol includes a deterrence protocol.

14. The method for portable crop management of claim 13, wherein the deterrence protocol activates upon verification of the at least one pest detected by the at least one drone.

15. The method for portable crop management of claim 10, wherein the at least one protocol defaults to a home protocol for the at least one drone based on a remaining power below a threshold.

16. The method for portable crop management of claim 10, wherein the at least one protocol includes a sheepdog protocol for herding a plurality of pests detected.

17. The method for portable crop management of claim 10, wherein the mobile unit includes a solar charging array to charge at least one battery of the mobile unit and the at least one drone.

18. A portable crop management system, comprising:
at least one mobile unit;
at least one drone including at least one mounted sensor; and
at least one base station;
wherein at least one pole-mounted sensor is operable to detect a location of at least one pest in a geographic area;
wherein the at least one drone includes a command drone and at least one support drone;
wherein the at least one base station is operable to activate at least one protocol to direct the command drone and/or the at least one support drone to the location of the at least one pest;
wherein the at least one protocol includes a pest deterrence protocol for deterring the at least one pest from the geographic area; and
wherein the at least one protocol is dynamically updated based on animal behavior and environmental conditions.

19. The portable crop management system of claim 18, wherein the at least one drone includes at least one on-drone sensor, wherein the at least one on-drone sensor includes a thermal imaging system and/or an optical sensor.

20. The portable crop management system of claim 18, wherein the at least one mobile unit includes a solar charging array to charge at least one battery of the at least one mobile unit, the command drone, and/or the at least one support drone.
